(19) United States
(12) Patent Application Publication
(10) Pub. No.: US 2024/0343583 A1
(43) Pub. Date: Oct. 17, 2024

(54) AQUEOUS CARBON NANOTUBE DISPERSION

(71) Applicant: OSAKA SODA CO., LTD., Osaka-shi, Osaka (JP)

(72) Inventors: Yasushi KONDA, Osaka-shi (JP); Mei SUEOKA, Osaka-shi (JP); Hayato WATANABE, Osaka-shi (JP)

(73) Assignee: OSAKA SODA CO., LTD., Osaka-shi, Osaka (JP)

(21) Appl. No.: 18/683,737

(22) PCT Filed: Aug. 17, 2022
(86) PCT No.: PCT/JP2022/031096

§ 371 Date: Feb. 14, 2024

(30) Foreign Application Priority Data
Sep. 3, 2021 (JP) 2021-143805

(51) Int. Cl. C01B 32/174

(52) U.S. Cl. CPC C01B 32/174; C01B 2202/30; C01B 2202/36; C01P 2002/82; C01P 2006/22; C01P 2006/80

(57) ABSTRACT

Provided is an aqueous carbon nanotube dispersion with excellent dispersibility of carbon nanotubes in water. An aqueous carbon nanotube dispersion containing carbon nanotubes dispersed in water, wherein the carbon nanotubes have a mean particle diameter (D50) of 1 μm or less, and when the carbon nanotubes are prepared as an aqueous dispersion with a concentration of 0.1% by mass, a spin-spin relaxation time (T22) of a second component is 1000 msec or less as measured by a measurement method as set forth below:

<Spin-Spin Relaxation Time (T22) of Second Component>

The spin-spin relaxation time (T22) of the second component is calculated by fitting a relaxation curve measured at 30° C. using an H nuclear CPMG pulse sequence method to a curve represented by expression (1):

$$\\ \begin{matrix}y ( t ) = {a}_{01} \times exp [ - ( t / T 21 ) ] + {a}_{02} \times exp [ - ( t / T 22 ) ] + {y}_{0} & expression ( 1 )\end{matrix}$$

where:
t is a capture time;
y(t) is a signal intensity at capture time t;
T21 is a spin-spin relaxation time of a first component;
T22 is the spin-spin relaxation time of the second component; and
y₀ is a signal intensity at capture time 0.

### TECHNICAL FIELD

The present invention relates to an aqueous carbon nanotube dispersion.

### BACKGROUND ART

Carbon nanotubes are used in various applications, such as conductive fillers, thermally conductive materials, light emitting elements, electrode materials, electrode bonding materials, reinforcing materials, and black pigments (see, for example, Patent Literature 1).

Carbon nanotubes are microscopic structures nanometer-sized in diameter and have poor handleability and workability by themselves. Thus, carbon nanotubes are commonly produced as dispersions of the carbon nanotubes in water, for use in various applications.

Unfortunately, carbon nanotubes tend to aggregate very easily in water because of their high crystallinity and the like, and cannot sufficiently exhibit their properties when used as aqueous dispersions in various applications.

### CITATION LIST

### Patent Literature

Patent Literature 1: Japanese Patent No. 6822124

### SUMMARY OF INVENTION

### Technical Problem

Under such circumstances, it is a main object of the present invention to provide an aqueous carbon nanotube dispersion with excellent dispersibility of carbon nanotubes in water.

### Solution to Problem

The present inventors have conducted extensive research to solve the foregoing problem. As a result, the inventors have found that, in an aqueous carbon nanotube dispersion containing carbon nanotubes dispersed in water, wherein the carbon nanotubes have a mean particle diameter (D50) of 1 μm or less, and wherein the carbon nanotubes are prepared as an aqueous dispersion with a concentration of 0.1% by mass, adjusting a spin-spin relaxation time (T22) of a second component to a predetermined value or less as measured by an H nuclear CPMG pulse sequence method significantly improves the dispersibility of the carbon nanotubes in water, for example, greatly reduces the sedimentation rate of the carbon nanotubes in the aqueous carbon nanotube dispersion (which means that the carbon nanotubes are highly dispersed in water with high stability).

The inventors have also found that it is effective to highly disentangle (bundles of) carbon nanotubes by performing a predetermined mechanical treatment and a predetermined chemical treatment in the production process of the aqueous carbon nanotube dispersion, in order to adjust the spin-spin relaxation time (T22) of the second component as measured by the H nuclear CPMG pulse sequence method to a predetermined value or less, for the carbon nanotubes having a mean particle diameter (D50) of 1 μm or less.

Further research based on the foregoing findings has led to the completion of the present invention.

The present invention can be summarized as follows:

Item 1. An aqueous carbon nanotube dispersion containing carbon nanotubes dispersed in water,
wherein the carbon nanotubes have a mean particle diameter (D50) of 1 um or less, and
when the carbon nanotubes are prepared as an aqueous dispersion with a concentration of 0.1% by mass, a spin-spin relaxation time (T22) of a second component is 1000 msec or less as measured by a measurement method as set forth below:

### Spin-Spin Relaxation Time (T22) of Second Component

The spin-spin relaxation time (T22) of the second component is calculated by fitting a relaxation curve measured at 30° C. using an H nuclear CPMG pulse sequence method to a curve represented by expression (1):

$$\\ \begin{matrix}y ( t ) = {a}_{01} \times exp [ - ( t / T 21 ) ] + {a}_{02} \times exp [ - ( t / T 22 ) ] + {y}_{0} & expression ( 1 )\end{matrix}$$

where:
t is a capture time;
y(t) is a signal intensity at capture time t;
T21 is a spin-spin relaxation time of a first component;
T22 is the spin-spin relaxation time of the second component; and
y₀ is a signal intensity at capture time 0.

Item 2. The aqueous carbon nanotube dispersion according to item 1, wherein the carbon nanotubes have a spin-spin relaxation time (T21) of first component/spin-spin relaxation time (T22) of second component ratio (a first component fraction (T21/T22)) of 0.40 or more as measured by a measurement method as set forth below:

### First Component Fraction (T21/T22)

The spin-spin relaxation time (T21) of the first component, the spin-spin relaxation time (T22) of the second component, and the first component fraction (T21/T22) are calculated by fitting a relaxation curve measured at 30° C. using the H nuclear CPMG pulse sequence method to a curve represented by expression (1):

$$\\ \begin{matrix}y ( t ) = {a}_{01} \times exp [ - ( t / T 21 ) ] + {a}_{02} \times exp [ - ( t / T 22 ) ] + {y}_{0} & expression ( 1 )\end{matrix}$$

where:
t is a capture time;
y (t) is a signal intensity at capture time t;
T21 is the spin-spin relaxation time of the first component;
T22 is the spin-spin relaxation time of the second component; and
y₀ is a signal intensity at capture time 0.

Item 3. The aqueous carbon nanotube dispersion according to item 1 or 2, wherein the carbon nanotubes have a peak intensity ratio G/D of G band to D band of 50 or less, in a Raman spectrum at an excitation wavelength of 532 nm as measured by resonance Raman scattering.

Item 4. The aqueous carbon nanotube dispersion according to any one of items 1 to 3, wherein the carbon nanotubes as an aqueous carbon nanotube dispersion have a viscosity of 50 Pa·s or less as measured by a measurement method as set forth below:

### Method of Measuring Viscosity

An aqueous carbon nanotube dispersion with a concentration of 0.1% by mass is prepared, and a viscosity is measured using a rheometer under a 30° C. environment, a shear rate of 0.1 s⁻¹, and cone and plate: C35/2.

Item 5. The aqueous carbon nanotube dispersion according to any one of items 1 to 4, wherein the carbon nanotubes have a functional group content of 5 to 30 atm % based on a (O1s) spectrum due to a 1s orbital of an oxygen atom as measured by X-ray photoelectron spectroscopy.

Item 6. The aqueous carbon nanotube dispersion according to any one of items 1 to 5, wherein the carbon nanotubes have a peak temperature of 500 to 650° C. in a first-order differential curve of weight loss due to combustion.

Item 7. The aqueous carbon nanotube dispersion according to any one of items 1 to 6, wherein the aqueous carbon nanotube dispersion has a pH of 5.10 or less when prepared as an aqueous dispersion with a concentration of 0.1% by mass.

Item 8. The aqueous carbon nanotube dispersion according to any one of items 1 to 7, wherein when the carbon nanotubes are prepared as an aqueous dispersion with a concentration of 0.1% by mass, the aqueous carbon nanotube dispersion has a sedimentation rate of 150 μm/s or less as measured by disc centrifuge photosedimentometry.

### Advantageous Effects of Invention

According to the present invention, there is provided an aqueous carbon nanotube dispersion with excellent dispersibility of carbon nanotubes in water.

### DESCRIPTION OF EMBODIMENTS

### 1. Carbon Nanotube Dispersion

An aqueous carbon nanotube dispersion of the present invention is an aqueous carbon nanotube dispersion containing carbon nanotubes dispersed in water. The carbon nanotubes contained in the aqueous carbon nanotube dispersion of the present invention have a mean particle diameter (D50) of 1 μm or less, and when the carbon nanotubes are prepared as an aqueous dispersion with a concentration of 0.1% by mass, a spin-spin relaxation time (T22) of a second component is 1000 msec or less. Because of these features, in the aqueous carbon nanotube dispersion of the present invention, the carbon nanotubes have excellent dispersibility in water. The aqueous carbon nanotube dispersion of the present invention will be hereinafter described in detail.

As used herein, values connected with “to” refer to a numerical range including the values before and after “to” as the lower and upper limits. When a plurality of lower limits and a plurality of upper limits are mentioned separately, any lower limit and any upper limit may be selected and connected with “to”.

In the aqueous carbon nanotube dispersion of the present invention (hereinafter sometimes referred to as the aqueous dispersion of the present invention), how the carbon nanotubes are produced (production method) is not limited, and the carbon nanotubes may be those produced by any method as long as they achieve the effects of the present invention. Examples of methods of producing the carbon nanotubes include arc discharging, laser vaporization, and chemical vapor deposition (CVD), with chemical vapor deposition (CVD) being preferred. The carbon nanotubes may be any type of carbon nanotubes, and may be single-walled carbon nanotubes, double-walled carbon nanotubes, or multi-walled carbon nanotubes. In view of satisfactorily achieving the effects of the present invention, the carbon nanotubes are preferably single-walled carbon nanotubes. The aqueous carbon nanotube dispersion of the present invention may contain a single type of carbon nanotubes or a plurality of types of carbon nanotubes.

In the aqueous dispersion of the present invention, the carbon nanotubes have a mean particle diameter (D50) of 1 μm or less. In view of more satisfactorily achieving the effects of the present invention, the mean particle diameter (D50) of the carbon nanotubes is preferably 900 nm or less, more preferably 850 nm or less, still more preferably 800 nm or less. On the other hand, the mean particle diameter (D50) of the carbon nanotubes is preferably 10 nm or more, more preferably 20 nm or more, still more preferably 50 nm or more. The mean particle diameter (D50) of the carbon nanotubes is measured as described in the Examples section.

In the aqueous dispersion of the present invention, when the carbon nanotubes are prepared as an aqueous dispersion with a concentration of 0.1% by mass, the spin-spin relaxation time (T22) of the second component is 1000 msec or less as measured by the H nuclear CPMG pulse sequence method. In view of more satisfactorily achieving the effects of the present invention, the relaxation time is preferably 950 msec or less, more preferably 925 msec or less, still more preferably 900 msec or less. On the other hand, the relaxation time is preferably 10 msec or more, more preferably 20 msec or more, still more preferably 30 msec or more. The relaxation time is measured as described in the Examples section.

As a preferred method for adjusting the mean particle diameter (D50) of the carbon nanotubes to 1 μm or less and adjusting the spin-spin relaxation time (T22) of the second component to 1000 msec or less, it is effective to highly disentangle (bundles of) carbon nanotubes by performing a predetermined mechanical treatment and a predetermined chemical treatment in the production process of the aqueous carbon nanotube dispersion, as in a production method of the present invention as described below.

In view of more satisfactorily achieving the effects of the present invention, in the aqueous dispersion of the present invention, the carbon nanotubes preferably have a spin-spin relaxation time (T21) of first component/spin-spin relaxation time (T22) of second component ratio (a first component fraction (T21/T22)) of 0.35 or more, more preferably 0.38 or more, still more preferably 0.40 or more, even more preferably 0.41 or more, as measured by the H nuclear CPMG pulse sequence method. The upper limit of the spin-spin relaxation time (T21) of first component/spin-spin relaxation time (T22) of second component ratio is 1.0. The spin-spin relaxation time (T21) of first component/spin-spin relaxation time (T22) of second component ratio is measured as described in the Examples section. It is effective to highly disentangle (bundles of) carbon nanotubes by employing the production method of the present invention, in order to adjust the spin-spin relaxation time (T21) of first component/spin-spin relaxation time (T22) of second component ratio to 0.4 or more.

In view of more satisfactorily achieving the effects of the present invention, in the aqueous dispersion of the present invention, the carbon nanotubes preferably have a peak intensity ratio G/D of G band to D band of 50 or less, more preferably 40 or less, still more preferably 30 or less, even more preferably 20 or less, in a Raman spectrum at an excitation wavelength of 532 nm as measured by resonance Raman scattering. The peak intensity ratio G/D is preferably 0.1 or more, more preferably 0.5 or more, still more preferably 1.0 or more. As used herein, “peak intensity ratio” refers to “height ratio”.

In view of more satisfactorily achieving the effects of the present invention, in the aqueous dispersion of the present invention, the carbon nanotubes as an aqueous carbon nanotube dispersion sample preferably have a viscosity (shear rate: 0.1 s⁻¹) of 50 Pa·s or less, more preferably 45 Pa·s or less, still more preferably 40 Pa·s or less, even more preferably 35 Pa·s or less, as measured by a measurement method as set forth below. The viscosity is preferably 0.1 Pa·s or more, more preferably 0.5 Pa·s or more, still more preferably 1.0 Pa·s or more.

### Method of Measuring Viscosity

An aqueous carbon nanotube dispersion with a concentration of 0.1% by mass is prepared, and a viscosity is measured using a rheometer under a 30° C. environment, a shear rate of 0.1 s⁻¹, and cone and plate: C35/2.

In view of more satisfactorily achieving the effects of the present invention, in the aqueous dispersion of the present invention, when the shear rate is changed from 0.1 s⁻¹ to 1 s⁻¹ in the measurement method described above, the carbon nanotubes preferably have a viscosity (shear rate: 1 s⁻¹) of 10 Pa·s or less, more preferably 8 Pa·s or less, still more preferably 6 Pa·s or less. The viscosity is preferably 0.01 Pa·s or more, more preferably 0.05 Pa·s or more, still more preferably 0.1 Pa·s or more.

In view of more satisfactorily achieving the effects of the present invention, in the aqueous dispersion of the present invention, when the shear rate is changed from 0.1 s⁻¹ to 10 s⁻¹ in the measurement method described above, the carbon nanotubes preferably have a viscosity (shear rate: 10 s⁻¹) of 0.5 Pa·s or less, more preferably 0.4 Pa·s or less, still more preferably 0.3 Pa·s or less. The viscosity is preferably 0.001 Pa·s or more, more preferably 0.005 Pa·s or more, still more preferably 0.01 Pa·s or more.

In view of more satisfactorily achieving the effects of the present invention, in the aqueous dispersion of the present invention, when the shear rate is changed from 0.1 s⁻¹ to 100 s⁻¹ in the measurement method described above, the carbon nanotubes preferably have a viscosity (shear rate: 100 s⁻¹) of 0.05 Pa·s or less, more preferably 0.04 Pa·s or less, still more preferably 0.03 Pa·s or less. The viscosity is preferably 0.001 Pa·s or more, more preferably 0.005 Pa·s or more, still more preferably 0.01 Pa·s or more.

In view of more satisfactorily achieving the effects of the present invention, in the aqueous dispersion of the present invention, the carbon nanotubes preferably have a functional group content (atm %) of 5 to 30 atm %, more preferably 5 to 25 atm %, still more preferably 5 to 20 atm %, even more preferably 7 to 18 atm %, based on a (O1s) spectrum due to a 1s orbital of an oxygen atom as measured by XPS (X-ray photoelectron spectroscopy), under the below-described measurement conditions. The functional group content (atm %) is measured as described in the Examples section.

In view of more satisfactorily achieving the effects of the present invention, in the aqueous dispersion of the present invention, the carbon nanotubes preferably have a peak temperature of 500 to 650° C., more preferably 500 to 640° C., still more preferably 500 to 630° C., even more preferably 500 to 620° C., in a first-order differential curve of weight loss due to combustion. The peak temperature is measured as described in the Examples section.

In view of more satisfactorily achieving the effects of the present invention, the aqueous dispersion of the present invention preferably has a pH of 5.20 or less, more preferably 5.15 or less, still more preferably 5.10 or less, even more preferably 5.0 or less, most preferably 5.05 or less, when prepared as an aqueous dispersion with a concentration of 0.1% by mass. The pH is preferably 2.0 or more, more preferably 2.5 or more, still more preferably 2.8 or more. The pH is measured as described in the Examples section.

In the aqueous dispersion of the present invention, the carbon nanotubes as an aqueous carbon nanotube dispersion preferably have a sedimentation rate of 150 μm/s or less, more preferably 140 μm/s or less, still more preferably 130 μm/s or less, even more preferably 120 μm/s or less, as measured by disc centrifuge photosedimentometry. The sedimentation rate is preferably 2.0 μm/s or more, more preferably 5.0 μm/s or more, still more preferably 10 μm/s or more. The sedimentation rate of the aqueous carbon nanotube dispersion is calculated by analyzing the separation phenomenon of the carbon nanotubes in solution with elapsed time, using disc centrifuge photosedimentometry. The sedimentation rate is measured as described in the Examples section.

In the aqueous carbon nanotube dispersion of the present invention, the carbon nanotube content is not specifically limited as long as it does not interfere with the effects of the present invention. In view of more satisfactorily achieving the effects of the present invention, the carbon nanotube content is preferably 0.01 to 15% by mass, more preferably 0.05 to 15% by mass, still more preferably 0.1 to 15% by mass.

The aqueous carbon nanotube dispersion of the present invention may contain a liquid medium other than water. The type of liquid medium is not specifically limited as long as it does not interfere with the effects of the present invention, and may be, for example, either a polar solvent or a nonpolar solvent. When the aqueous dispersion of the present invention contains a liquid medium other than water, the liquid medium may be a single liquid medium or a plurality of liquid media. In view of more satisfactorily achieving the effects of the present invention, the liquid medium is preferably a polar solvent. Preferred polar solvents include, for example, alcohols such as ethanol and isopropanol, DMF, NMP, ethyl acetate, butyl acetate, and methyl ethyl ketone. As used herein, “aqueous carbon nanotube dispersion” means that the proportion of water in all the liquid media (including water) contained in the aqueous carbon nanotube dispersion is 50% by mass or more. The proportion of water in all the liquid media of the aqueous carbon nanotube dispersion is preferably 80% by mass or more, more preferably 90% by mass or more, still more preferably 100% by mass.

The aqueous carbon nanotube dispersion of the present invention may optionally contain additives contained in known aqueous carbon nanotube dispersions. Examples of such additives include dispersing agents and emulsifying agents. It is noted, however, that the aqueous carbon nanotube dispersion of the present invention need not contain a dispersing agent, and preferably contains no dispersing agent. Examples of dispersing agents include, but are not specifically limited to, surfactants such as anionic surfactants, cationic surfactants, and nonionic surfactants. By the phrase that the dispersion of the present invention contains no dispersing agent, it is meant that the dispersing agent content in the aqueous dispersion of the present invention is 0.01% by mass or less, preferably 0.001% by mass or less, more preferably 0.0001% by mass or less.

While the aqueous carbon nanotube dispersion of the present invention may be produced by any method, it can be produced satisfactorily by the below-described method of producing the aqueous carbon nanotube dispersion of the present invention.

Applications of the aqueous carbon nanotube dispersion of the present invention include, but are not specifically limited to, for example, antistatic materials, flexible electrodes, electrodes for wearable sensors, and conductive paints.

### 2. Method of Producing Aqueous Carbon Nanotube Dispersion

The aqueous carbon nanotube dispersion of the present invention may be produced by, for example, a method including the following steps:
step 1: subjecting a mixture of the carbon nanotubes and water to coarse dispersion treatment to give a coarse dispersion;
step 2: subjecting the coarse dispersion obtained in step 1 to mechanical dispersion treatment to give a mechanical dispersion; and
step 3: subjecting the mechanical dispersion obtained in step 2 to oxidation treatment to give the aqueous carbon nanotube dispersion of the present invention.

When the aqueous carbon nanotube dispersion is produced specifically by employing preferred conditions as described below in each of steps 1 to 3, the aqueous carbon nanotube dispersion of the present invention is produced satisfactorily, wherein the carbon nanotubes have a mean particle diameter (D50) of 1 μm or less, and have a property that when the carbon nanotubes are prepared as an aqueous dispersion with a concentration of 0.1% by mass, the spin-spin relaxation time (T22) of the second component is 1000 msec or less as measured by the H nuclear CPMG pulse sequence method, and the carbon nanotubes further have various properties as described above. In the method of producing the aqueous carbon nanotube dispersion of the present invention, the carbon nanotubes and the like are as described in the “1. Aqueous Carbon Nanotube Dispersion” section above.

### Step 1

Step 1 is the step of subjecting a mixture of the carbon nanotubes and water to coarse dispersion treatment to give a coarse dispersion.

Specifically, in step 1, the carbon nanotubes and water are mixed, and the mixture is stirred using a stirrer to give a coarse dispersion in which the carbon nanotubes are dispersed in water.

In step 1, stirring with a stirrer preferably employs a combination of forward rotation and reverse rotation, in order to improve the dispersibility of the carbon nanotubes. The stirring rate is preferably 1500 rpm or more, more preferably 1800 rpm or more, still more preferably 2000 rpm or more. The stirring time may vary with the volume to be dispersed. For example, when the volume to be dispersed is 1 L, the stirring time is preferably 0.1 to 2 hours, more preferably 0.1 to 1.5 hours, still more preferably 0.25 to 1 hour; and when the volume to be dispersed is 10 L, the stirring time is preferably 0.5 to 12 hours, more preferably 0.5 to 9 hours, still more preferably 1 to 6 hours, and even more preferably 0.1 to 12 hours. Stirring is preferably performed a plurality of times, in view of further improving the dispersibility of the carbon nanotubes.

The temperature condition during stirring in step 1 is preferably 10 to 40° C., more preferably 15 to 35° C., still more preferably 18 to 30° C.

The concentration of the carbon nanotubes in the mixture is preferably 0.01 to 2.0% by mass, more preferably 0.01 to 1.8% by mass, still more preferably 0.01 to 1.5% by mass.

The mean particle diameter (D50) of the carbon nanotubes in the mixture is preferably 3.5 mm or less, more preferably 3.0 mm or less, still more preferably 2.5 mm or less. The mean particle diameter (D50) of the carbon nanotubes is measured as described in the Examples section (in the same manner as in the method of measuring the mean particle diameter (D50) of the carbon nanotubes in the dispersion).

### Step 2

Step 2 is the step of subjecting the coarse dispersion obtained in step 1 to mechanical dispersion treatment to give a mechanical dispersion.

In step 2, (bundles of) carbon nanotubes are mechanically disentangled using an ultra-high pressure wet pulverization apparatus or the like, in order to further improve the dispersibility of the carbon nanotubes contained in the coarse dispersion obtained in step 1.

In step 2, preferably, the nozzle size of the ultra-high pressure wet pulverization apparatus is gradually reduced to improve the dispersibility of the carbon nanotubes. The discharge pressure is preferably 100 MPa or more, more preferably 110 MPa or more, still more preferably 120 MPa or more. While the number of circulation passes may vary with the percent by mass of the carbon nanotubes, for example, in the case of 0.2% by mass of the carbon nanotubes, the number of circulation passes is preferably 5 or more, more preferably 10 or more, still more preferably 15 or more. The mechanical treatment is preferably performed a plurality of times, in view of further improving the dispersibility of the carbon nanotubes.

The temperature condition during the mechanical treatment in step 2 is preferably 20 to 50° C., more preferably 20 to 45° C., still more preferably 20 to 40° C.

The concentration of the carbon nanotubes in the mechanical dispersion is preferably 0.01 to 0.5% by mass, more preferably 0.01 to 0.4% by mass, still more preferably 0.05 to 0.3% by mass.

The mean particle diameter (D50) of the carbon nanotubes in the mechanical dispersion is preferably 250 μm or less, more preferably 200 μm or less, still more preferably 150 μm or less. On the other hand, the mean particle diameter (D50) of the carbon nanotubes is, for example, 30 μm or more, preferably 40 μm or more. The mean particle diameter (D50) of the carbon nanotubes is preferably 0.1 μm or more, more preferably 0.2 μm or more, still more preferably 0.5 μm or more. The mean particle diameter (D50) of the carbon nanotubes is measured as described in the Examples section (in the same manner as in the method of measuring the mean particle diameter (D50) of the carbon nanotubes in the dispersion).

### Step 3

Step 3 is the step of subjecting the mechanical dispersion obtained in step 2 to oxidation treatment to give the aqueous carbon nanotube dispersion of the present invention.

In step 3, the (bundles of) carbon nanotubes are further disentangled by subjecting the carbon nanotubes to oxidation treatment, in order to further improve the dispersibility of the carbon nanotubes contained in the mechanical dispersion obtained in step 2.

While the method of oxidation treatment for the carbon nanotubes is not specifically limited as long as it can produce the aqueous carbon nanotube dispersion of the present invention, the method of oxidation treatment is preferably ozone treatment, which can produce the aqueous carbon nanotube dispersion of the present invention.

Preferred conditions of the ozone treatment are as follows: The concentration of the carbon nanotubes in the mechanical dispersion described above to be subjected to the ozone treatment is preferably 0.001 to 0.5% by mass, more preferably 0.01 to 0.4% by mass, still more preferably 0.02 to 0.2% by mass, as described above.

The ozone concentration in the ozone treatment is preferably 0.1 to 500 g/m³ (N), more preferably 1 to 400 g/m³ (N), still more preferably 2 to 200 g/m³ (N).

The temperature condition in the ozone treatment is preferably 10 to 40° C., more preferably 10 to 38° C., still more preferably 15 to 35° C.

While the ozone treatment time may vary with the volume and the percent by mass of the carbon nanotubes, for example, in the case of 10 L of 0.1% by mass of the carbon nanotubes, the ozone treatment time is preferably 0.1 to 100 hours, more preferably 0.2 to 80 hours, still more preferably 0.3 to 50 hours.

### Examples

The present invention will be hereinafter described in more detail with examples; however, the following examples are in no way intended to limit the scope of protection of the present invention.

### Production of Aqueous Carbon Nanotube Dispersion

### Example 1

### (1) Coarse Dispersion Treatment

A 2 L polyethylene container was charged with 1,480 g of ion-exchanged water and 20 g of 5 cm square sheet carbon nanotubes (OStube from OSAKA SODA CO., LTD.). T.K ROBOMICS from PRIMIX Corporation was used to subject the mixture to dispersion treatment by performing a total of 5 sets of 10 seconds of forward rotation at 5,000 rpm and 10 seconds of reverse rotation at 5,000 rpm. Then, 500 g of ion-exchanged water was added, and the same equipment was used to disperse the mixture by performing 2 sets of 60 seconds of forward rotation at 4,000 rpm and 5 seconds of reverse rotation at 4,000 rpm, thus giving 24 kg of a 1.0% by mass aqueous carbon nanotube coarse dispersion. A 20 L polyethylene container was charged with 16 kg of ion-exchanged water and 4 kg of the 1.0% by mass aqueous carbon nanotube coarse dispersion, and the mixture was dispersed for 3 hours using the MARK II homomixer from PRIMIX Corporation with the dial set at 4, thus giving 20 kg of a 0.2% by mass aqueous carbon nanotube coarse dispersion. Observation of the particle size of the carbon nanotubes using the VHX-6000 digital microscope from KEYENCE CORPORATION showed that the mean particle diameter (D50) was 1.8 mm.

### (2) Mechanical Dispersion Treatment

Then, the coarse dispersion obtained above was passed once through a unit having a hose outlet equipped with a spray nozzle with a hole diameter of 3.5 mm and subjected to dispersion treatment using Star Burst 100 from SUGINO MACHINE LIMITED with a single chamber (nozzle diameter: 0.5 mm, 245 MPa, 10 passes). Then, the coarse dispersion was subjected to dispersion treatment using a slit chamber (nozzle diameter: 0.23 mm, 150 MPa, 50 passes), thus giving 18 kg of a 0.2% by mass carbon nanotube dispersion. Observation of the particle size of the carbon nanotubes using the VHX-6000 digital microscope from KEYENCE CORPORATION showed that the mean particle diameter (D50) was 100 μm.

### (3) Ozone Treatment

Then, an acrylic reaction vessel (φ66 mm×H 3000 mm) was charged with 4.5 kg of the 0.2% by mass aqueous carbon nanotube dispersion and 4.5 kg of ion-exchanged water, and the mixture was circulated up and down for 5 minutes with a magnetic pump (flow rate: 5 L/min), thus preparing a 0.1% by mass aqueous carbon nanotube dispersion. While continuing circulation, the aqueous dispersion was reacted with ozone gas (ozone concentration 100 g/m³ (N)) produced using the PSA ozonizer from SUMITOMO PRECISION PRODUCTS Co., Ltd. at 0.5 L/min (N) for 100 minutes, thus giving 7.2 kg of a 0.1% by mass aqueous carbon nanotube dispersion with excellent water dispersibility. Observation of the particle size of the carbon nanotubes using the LA-950V2 laser diffraction particle size distribution analyzer from HORIBA showed that the mean particle diameter (D50) of the carbon nanotubes contained in the aqueous carbon nanotube dispersion was 0.5 μm.

### Example 2

The same procedure as Example 1 was used, except that the reaction time with ozone gas was changed from “100 minutes” to “150 minutes”, thus giving a 0.1% by mass aqueous carbon nanotube dispersion.

### Example 3

The same procedure as Example 1 was used, except that the reaction time with ozone gas was changed from “100 minutes” to “225 minutes”, thus giving a 0.1% by mass aqueous carbon nanotube dispersion.

### Example 4

The same procedure as Example 1 was used, except that the reaction time with ozone gas was changed from “100 minutes” to “300 minutes”, thus giving a 0.1% by mass aqueous carbon nanotube dispersion.

### Comparative Example 1

The same procedure as Example 1 was used, except that the ozone treatment was not performed, thus giving a 0.1% by mass aqueous carbon nanotube dispersion.

### Comparative Example 2

The same procedure as Example 1 was used, except that the reaction time with ozone gas was changed from “100 minutes” to “15 minutes”, thus giving a 0.1% by mass aqueous carbon nanotube dispersion.

### Comparative Example 3

The same procedure as Example 1 was used, except that the reaction time with ozone gas was changed from “100 minutes” to “50 minutes”, thus giving a 0.1% by mass aqueous carbon nanotube dispersion.

### Comparative Example 4

The same procedure as Example 1 was used, except that the reaction time with ozone gas was changed from “100 minutes” to “50 minutes”, thus giving a 0.1% by mass aqueous carbon nanotube dispersion.

### Measurement of Spin-Spin Relaxation Time (T22) of Second Component and First Component Fraction (T21/T22)

For the carbon nanotubes contained in each of the 0.1% by mass aqueous carbon nanotube dispersions obtained in the examples and comparative examples, a spin-spin relaxation time (T22) of a second component and a first component fraction (T21/T22) were calculated according to the following procedure. Using the pulsed NMR evaluation apparatus for particle interface properties, “Spin track”, from Resonance System, a relaxation curve measured at 30° C. using an H nuclear CPMG pulse sequence method was fitted to a curve represented by expression (1) shown below to calculate a spin-spin relaxation time (T21) of a first component, the spin-spin relaxation time (T22) of the second component, and the first component fraction (T21/T22). The results are shown in Table 1.

$$\\ \begin{matrix}y ( t ) = {a}_{01} \times exp [ - ( t / T 21 ) ] + {a}_{02} \times exp [ - ( t / T 22 ) ] + {y}_{0} & expression ( 1 )\end{matrix}$$

where:
t is a capture time;
y(t) is a signal intensity at capture time t;
T21 is the spin-spin relaxation time of the first component;
T22 is the spin-spin relaxation time of the second component; and
y₀ is a signal intensity at capture time 0.

### Measurement of Mean Particle Diameter (D50)

For the carbon nanotubes contained in each of the aqueous carbon nanotube dispersions obtained in the examples and comparative examples, a mean particle diameter (D50) was measured. The mean particle diameter (D50) was measured as follows: A laser diffraction/scattering particle size distribution analyzer (product name “LA-950V2” from HORIBA) was used to measure a particle size distribution (volume-based). In the particle size distribution obtained, the particle diameter (μm) at a cumulative volume of 50% as calculated from the small diameter side was determined as the volume mean particle diameter D50.

### Measurement of Peak Intensity Ratio G/D

For the carbon nanotubes contained in each of the aqueous carbon nanotube dispersions obtained in the examples and comparative examples, a peak intensity ratio G/D was measured according to the following procedure. Using a Raman spectrometer, the peak intensity ratio of G band (near 1590 cm⁻¹) to D band (near 1300 cm⁻¹) was calculated in a Raman spectrum as measured by resonance Raman scattering (excitation wavelength 532 nm). The results are shown in Table 1.

### Viscosity Measurement of Carbon Nanotube Dispersion

For the carbon nanotubes contained in each of the aqueous carbon nanotube dispersions obtained in the examples and comparative examples, a viscosity of the aqueous carbon nanotube dispersion was measured by the following measurement method. A rheometer was used to measure the viscosity of the sample under a 30° C. environment, a shear rate of 0.1 s⁻¹, and cone and plate: C35/2. The results are shown in Table 1.

### XPS Measurement of Content of Introduced Functional Groups

For the carbon nanotubes contained in each of the aqueous carbon nanotube dispersions obtained in the examples and comparative examples, a content (atm %) of introduced functional groups was measured based on a (O1s) spectrum due to a 1s orbital of an oxygen atom by XPS (X-ray photoelectron spectroscopy). Specifically, the content of introduced oxygen functional groups was determined by elemental analysis of the carbon nanotube surface using Al-Kα as the X-ray source, using the AXIS-ULTRA DLD X-ray photoelectron spectrometer from KURATOS, based on X-ray photoelectron spectroscopy (XPS/ESCA). The results are shown in Table 1.

### Measurement of Peak Temperature in First-Order Differential Curve of Weight Loss Due to Combustion

For the carbon nanotubes contained in each of the aqueous carbon nanotube dispersions obtained in the examples and comparative examples, a peak temperature in a first-order differential curve of weight loss due to combustion (DTG (TG/DTA)) was measured. The peak temperature in a first-order differential curve of weight loss due to combustion was measured as follows: The STAR7200RV simultaneous thermogravimetry/differential thermal analyzer from Hitachi High-Tech Corporation was used to measure a thermogravimetry curve of the carbon nanotubes under a heating rate of 5° C./min and a drying air flow rate of 100 mL/min, and then a first-order differential curve was obtained.

### pH Measurement of Aqueous Carbon Nanotube Dispersion

The pH of each of the carbon nanotube dispersions obtained in the examples and comparative examples was measured. The pH was measured at 25° C. using the D74 portable pH meter from HORIBA. The results are shown in Table 1.

### Dispersion Stability (Sedimentation Rate)

Dispersion stability (sedimentation rate) of each of the aqueous carbon nanotube dispersions obtained in the examples and comparative examples was evaluated according to the following procedure. Dispersion stability was evaluated by the method referred to as disc centrifuge photosedimentometry, using the sedimentation rate in solution of the carbon nanotubes measured using the model LS-610 dispersibility evaluation/particle size distribution analysis apparatus from LUM Japan. Specifically, 0.4 ml of the 0.1% by mass aqueous dispersion of the carbon nanotubes was weighed into a 20 mL glass vial, a sample cell containing the measurement sample was rotated at a high speed of 3000 rpm, and the separation phenomenon of the particles at the center of the cell was analyzed with elapsed time. In this way, the sedimentation rate of the carbon nanotubes was calculated. The above-mentioned measurement apparatus incorporates data analysis software, which allows automatic analysis of measured data to calculate the sedimentation rate. The results are shown in Table 1.

Table 1 below shows the physical properties and the like of the carbon nanotubes used in the examples and comparative examples and aqueous dispersions thereof.

TABLE 1

| Physical properties of CNTs | | | Comp. | Comp. | Comp. | Comp. | | | | |
|---|---|---|---|---|---|---|---|---|---|---|
| (aqueous dispersion) | | Unit | Ex. 1 | Ex. 2 | Ex. 3 | Ex. 4 | Ex. 1 | Ex. 2 | Ex. 3 | Ex. 4 |
| Spin-spin relaxation time (T22) of | | msec | 1520 | 1055 | 808 | 596 | 534 | 469 | 562 | 758 |
| second component | | | | | | | | | | |
| Mean particle diameter (D50) | | μm | 109.6 | 37.21 | 25.25 | 15.42 | 0.52 | 0.50 | 0.49 | 0.49 |
| Spin-spin relaxation time (T21) of | | — | 0.27 | 0.37 | 0.46 | 0.46 | 0.41 | 0.42 | 1.00 | 1.00 |
| first component/spin-spin relaxation time | | | | | | | | | | |
| (T22) of second component ratio | | | | | | | | | | |
| G/D ratio | | — | 11 | 7 | 6 | 5 | 5 | 5 | 3 | 3 |
| Viscosity | Shear rate 0.1s⁻¹ | Pa · s | 166.0 | 150.0 | 130.0 | 82.0 | 35.0 | 16.0 | 6.2 | 4.0 |
| | Shear rate 1.0s⁻¹ | | 16.0 | 15.0 | 15.0 | 11.0 | 5.5 | 3.8 | 1.2 | 1.2 |
| | Shear rate 10s⁻¹ | | 1.24 | 1.17 | 0.78 | 0.63 | 0.20 | 0.20 | 0.07 | 0.06 |
| | Shear rate 100s⁻¹ | | 0.12 | 0.16 | 0.10 | 0.08 | 0.02 | 0.02 | 0.01 | 0.01 |

| | | | | | | | | | |
|---|---|---|---|---|---|---|---|---|---|
| Functional group content measured | atm % | 1.33 | 3.05 | 4.7 | 6.08 | 7.23 | 9.67 | 11.8 | 14.95 |
| by XPS (O1s) | | | | | | | | | |
| Peak temperature in first-order | ° C. | 658 | 633 | 628 | 583 | 617 | 610 | 598 | 513 |
| differential curve of weight loss by | | | | | | | | | |
| DTG (TG/DTA) | | | | | | | | | |
| pH of CNT dispersion | — | 7.75 | 6.17 | 5.4 | 5.21 | 5.01 | 4.23 | 3.57 | 3.15 |
| Dispersion stability | μm/s | 773 | 478 | 180 | 130 | 117 | 29 | 22 | 24 |
| (sedimentation rate) | | | | | | | | | |

1. An aqueous carbon nanotube dispersion containing carbon nanotubes dispersed in water,
wherein the carbon nanotubes have a mean particle diameter (D50) of 1 μm or less, and
when the carbon nanotubes are prepared as an aqueous dispersion with a concentration of 0.1% by mass. a spin-spin relaxation time (T22) of a second component is 1000 msec or less as measured by a measurement method as set forth below:
<Spin-Spin Relaxation Time (T22) of Second Component>
The spin-spin relaxation time (T22) of the second component is calculated by fitting a relaxation curve measured at 30° C. using an H nuclear CPMG pulse sequence method to a curve represented by expression (1):
$$\\ \begin{matrix}y ( t ) = {a}_{01} \times exp [ - ( t / T 21 ) ] + {a}_{02} \times exp [ - ( t / T 22 ) ] + {y}_{0} & expression ( 1 )\end{matrix}$$
where:
t is a capture time;
y(t) is a signal intensity at capture time t;
T21 is a spin-spin relaxation time of a first component;
T22 is the spin-spin relaxation time of the second component; and
y₀ is a signal intensity at capture time 0.

2. The aqueous carbon nanotube dispersion according to claim 1, wherein the carbon nanotubes have a spin-spin relaxation time (T21) of first component/spin-spin relaxation time (T22) of second component ratio (a first component fraction (T21/T22)) of 0.40 or more as measured by a measurement method as set forth below:
<First Component Fraction (T21/T22) >
The spin-spin relaxation time (T21) of the first component, the spin-spin relaxation time (T22) of the second component, and the first component fraction (T21/T22) are calculated by fitting a relaxation curve measured at 30° C. using the H nuclear CPMG pulse sequence method to a curve represented by expression (1):
$$\\ \begin{matrix}y ( t ) = {a}_{01} \times exp [ - ( t / T 21 ) ] + {a}_{02} \times exp [ - ( t / T 22 ) ] + {y}_{0} & expression ( 1 )\end{matrix}$$
where:
t is a capture time;
y(t) is a signal intensity at capture time t;
T21 is the spin-spin relaxation time of the first component;
T22 is the spin-spin relaxation time of the second component; and
y₀ is a signal intensity at capture time 0.

3. The aqueous carbon nanotube dispersion according to claim 1, wherein the carbon nanotubes have a peak intensity ratio G/D of G band to D band of 50 or less, in a Raman spectrum at an excitation wavelength of 532 nm as measured by resonance Raman scattering.

4. The aqueous carbon nanotube dispersion according to claim 1, wherein the carbon nanotubes as an aqueous carbon nanotube dispersion have a viscosity of 50 Pa·s or less as measured by a measurement method as set forth below:
<Method of Measuring Viscosity>
An aqueous carbon nanotube dispersion with a concentration of 0.1% by mass is prepared, and a viscosity is measured using a rheometer under a 30° C. environment, a shear rate of 0.1 s⁻¹, and cone and plate: C35/2.

5. The aqueous carbon nanotube dispersion according to claim 1, wherein the carbon nanotubes have a functional group content of 5 to 30 atm % based on a (O1s) spectrum due to a 1s orbital of an oxygen atom as measured by X-ray photoelectron spectroscopy.

6. The aqueous carbon nanotube dispersion according to claim 1, wherein the carbon nanotubes have a peak temperature of 500 to 650° C. in a first-order differential curve of weight loss due to combustion.

7. The aqueous carbon nanotube dispersion according to claim 1, wherein the aqueous carbon nanotube dispersion has a pH of 5.10 or less when prepared as an aqueous dispersion with a concentration of 0.1% by mass.

8. The aqueous carbon nanotube dispersion according to claim 1, wherein when the carbon nanotubes are prepared as an aqueous dispersion with a concentration of 0.1% by mass, the aqueous carbon nanotube dispersion has a sedimentation rate of 150 μm/s or less as measured by disc centrifuge photosedimentometry.
